(19) United States
(12) Patent Application Publication
(10) Pub. No.: US 2024/0070771 A1
(43) Pub. Date: Feb. 29, 2024

(54) SYSTEM AND METHOD FOR APPLYING USER DATA IN ACCESSING OF INSTITUTIONAL PRODUCTS

(71) Applicant: Royal Bank of Canada, Toronto (CA)

(72) Inventors: Nohra Beltran, Calgary (CA); Dana AISibai, Oakville (CA); Christopher Cliff, Edmonton (CA); Hariish Nandakumar, Burnaby (CA); Hannah Mclsaac, Winnipeg (CA); Kelly Goncalves, Toronto (CA); Selene Soo, Mississauga (CA); Chai Lam, Toronto (CA)

(21) Appl. No.: 18/233,466

(22) Filed: Aug. 14, 2023

Related U.S. Application Data
(60) Provisional application No. 63/400,528, filed on Aug. 24, 2022.

(51) Int. Cl. G06Q 40/02; G06Q 40/08

(52) U.S. Cl. CPC G06Q 40/02; G06Q 40/08

(57) ABSTRACT

A method on applying user data for providing services to a user from a platform of services, the method comprising the steps of: obtaining user profile data pertaining to the user of a network system of an institution; comparing the user profile data to a plurality of different potential life stages in order to determine a selected life stage; identifying one or more services from the platform of services based on the selected life stage; identifying the one or more services to the user via a user interface of a user device; receiving a request from the user through the user device for access to the one or more services; and updating contents of the user profile to include additional profile content related to activity of the user with the one or more services.

### TECHNICAL FIELD

The present disclosure is directed at methods, systems, and techniques for processing of user data in network environments.

### BACKGROUND

In the evolving financial landscape of today, everyone knows that financial literacy is important. The real challenge is that financial literacy can be considered boring, irrelevant, non-relatable, and not actionable to people in their day to day lives. That being said, other problems with financial content being served on the internet can be misinformation, impersonalized, and distributed. Similar any content on the internet, you are unsure if you can trust it or not, one blog could say one thing and another blog can say that it's utter nonsense.

Further, there is a need for institutions to have improved contact with their customers, especially in the area of wealth transfer, especially for relatives and other family members of an institution's customer. In particular, financial institutions need to be on good relationship terms with both benefactors and beneficiaries when in circumstances of wealth transfer events.

### SUMMARY

An object of the present invention is to provide a system and/or method of applying user data to obviate or mitigate at least one of the above-presented disadvantages of the state of the art.

According to a first aspect, there is provided a method on applying user data for providing services to a user from a platform of services, the method comprising the steps of: obtaining stored user profile data pertaining to the user of a network system of an institution; comparing the user profile data to a plurality of different potential life stages in order to determine a selected life stage; identifying one or more services from the platform of services based on the selected life stage; identifying the one or more services to the user via a user interface of a user device; receiving a request from the user through the user device for access to the one or more services; and updating contents of the stored user profile to include additional profile content related to activity of the user with the one or more services.

A further aspect provided is a computer system for manipulating and maintaining a user profile including applying user data for providing services to a user from a platform of services, the system comprising: a set of stored instructions for execution by one or more computer processors for: obtaining stored user profile data pertaining to the user of a network system of an institution; comparing the user profile data to a plurality of different potential life stages in order to determine a selected life stage; identifying one or more services from the platform of services based on the selected life stage; identifying the one or more services to the user via a user interface of a user device; receiving a request from the user through the user device for access to the one or more services; and updating contents of the stored user profile to include additional profile content related to activity of the user with the one or more services.

A further aspect provided is a computer readable medium having a set of stored instructions for execution by one or more computer processors for manipulating and maintaining a user profile including applying user data for providing services to a user from a platform of services, the set of stored instructions including: obtaining stored user profile data pertaining to the user of a network system of an institution; comparing the user profile data to a plurality of different potential life stages in order to determine a selected life stage; identifying one or more services from the platform of services based on the selected life stage; identifying the one or more services to the user via a user interface of a user device; receiving a request from the user through the user device for access to the one or more services; and updating contents of the stored user profile to include additional profile content related to activity of the user with the one or more services.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows an example system diagram of a networked system for providing access by a user to provided services of an institution;

FIG. 1;

FIG. 2 shows a block diagram of the example computing device of the system of FIG. 3 shows an example configuration of the system of FIG. 1;

FIG. 4 shows an example configuration of a recommendation system of the system of FIG. 3;

FIG. 5 shows a further example configuration of the recommendation system of the system of FIG. 3;

FIG. 6 shows a logic diagram of the system of FIG. 1;

FIG. 7 shows an example configuration of an event prediction system of the system of FIG. 3;

FIG. 3;

FIG. 8 shows an example aspect of the recommendation system of the system of FIG. 9 shows a further example aspect of the recommendation system of the system of FIG. 3;

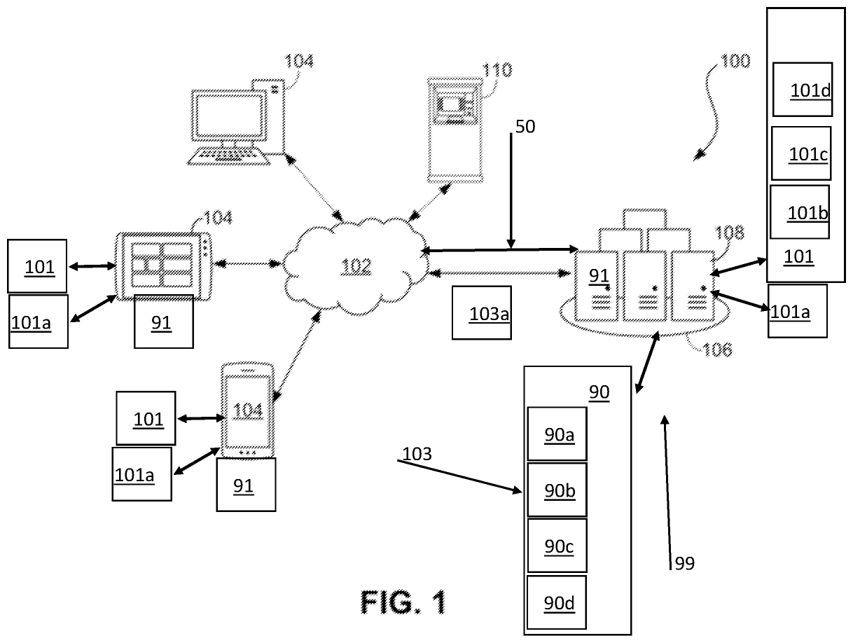

FIG. 10 is an example operation of the system of FIG. 1;

FIG. 11 shows an example tech stack of the system of FIG. 1;

FIG. 12 shows a further block diagram of the tech stack of FIG. 11;

FIG. 13 shows example user interface content for different users of the system of FIG. 1; and

FIG. 14 shows further example user interface content for different users of the system of FIG. 1.

### DETAILED DESCRIPTION

In at least some embodiments herein, methods, systems, and techniques for manipulating and updating a user profile 101, including accessing and using application interactions 101a (also referred to as user application history 101a).

Referring now to FIG. 1, there is shown a computer network 100 that comprises

an example embodiment of a system 99 for manipulating and maintaining the user profile 101. More particularly, the computer network 100 comprises a wide area network 102 such as the Internet to which various user devices 104 (for example a mobile device), an ATM 110, and data center 106 are communicatively coupled. The data center 106 comprises a number of servers 108 networked together to collectively perform various computing functions. For example, in the context of a financial institution such as a bank (one example of an institution), the data center 106 may host online banking services that facilitates users to log in to those servers 108 using user accounts that give them access to various computer-implemented banking services, such as online fund transfers. For example, in the context of a financial institution such as a bank, the data center 106 can host an online service application 91 that facilitates users to log in to those servers 108 using user accounts, for example, that give the user access to various computer-implemented user profile functionality, such maintaining of user profiles 101 and user application interactions 101a, as well as access to served content 103 (e.g. supplied by a service platform 90 for services 90a,b,c,d). For example, the user service platform 90 can be accessed via the network 102 using a client—server model, e.g. the service application 91 executed on the user device 104 (or otherwise hosted on the system 99) that communicates with the service platform 90 hosted on one or more of the servers 108.

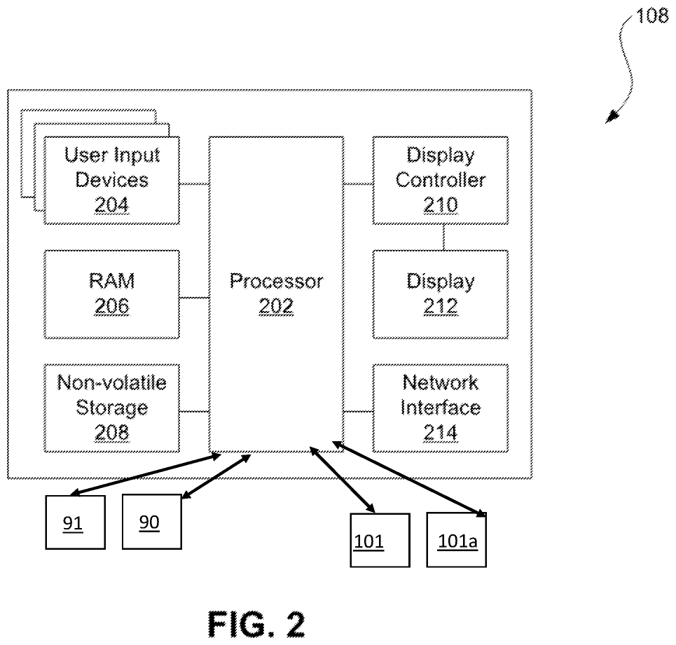

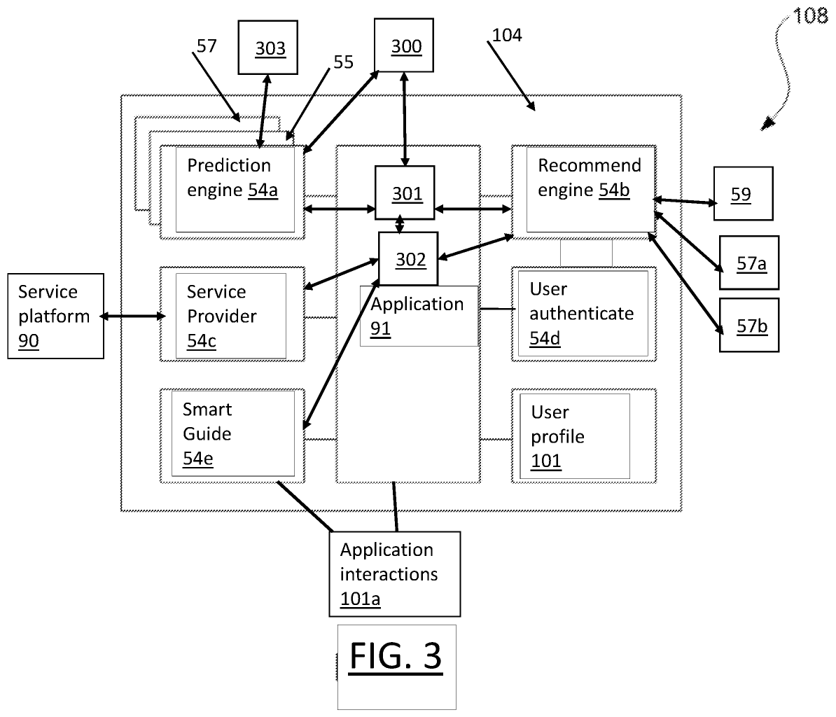

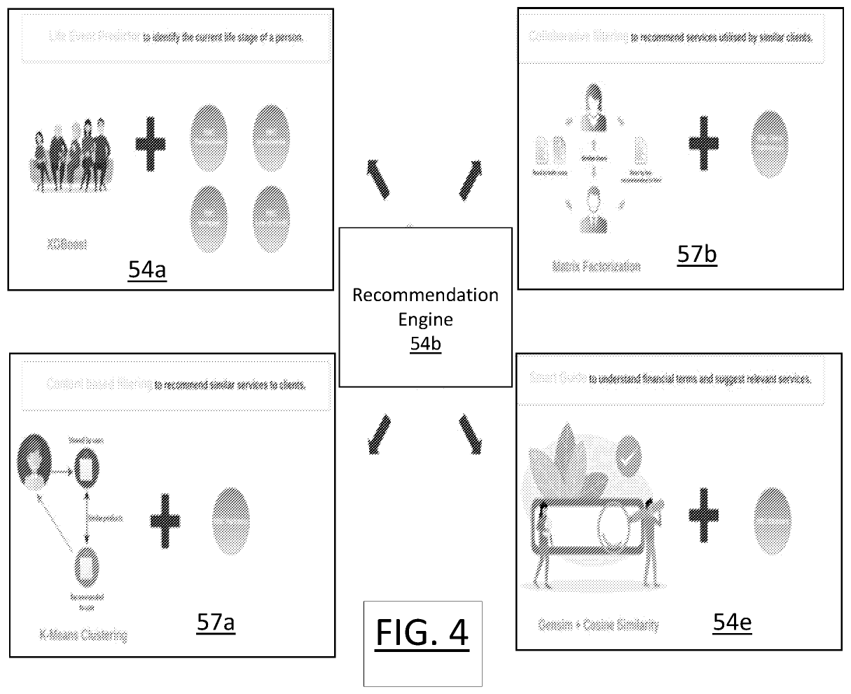

Furthermore, individuals may appear in person at the ATM 110 to withdraw money from bank accounts controlled by the data center 106, as well as perform other financial services (e.g. credit card transactions) which are recorded and stored as transactional data 101b in the user profile 101. The data center 106 can generate the user profile 101 based on a number of criteria, and can manipulate the user profile 101 in order to provide access to one or more services 90a,b,c,d to the user for presentation on a user interface 212 (see FIG. 2) of the user device 104. It is recognised that as the user interacts with services provided by the data center 106, the data contents of the user profile 101 are updated to reflect changes (e.g. additional financial transactions, new services such as insurance, mortgages, etc.) to the data of the user. It is also recognised that the user can provide data (e.g. demographic data) to the system 99 for use in updating the user profile 101. Alternatively, the system 99 can access transactional data associated with the user in order to update the contents of the user profile 101. One example of this update is where the user is a of first user type (e.g. benefactor) and the system determines that the user is associated (e.g. associated by family/personal relationship(s)) with other users/potential users of the system 99. These other users/potential users can be referred to as a second user type by the system 99, e.g. a beneficiary. In this regard, it is recognised that the contents of the user profile can reflect both content associated with the user of the first user type as well as content associated with the other user(s)/potential user(s) of the second user type. For example, the first user type can be a benefactor and the second user type can be a beneficiary (of the benefactors wealth) when a life event of wealth transfer occurs. For example, the content of the user profile 101 (of the benefactor) can be updated to include contact information, financial information, life event status information, etc. of the beneficiary once identified/determined by the system 99. It is also recognised that the users can invite one another to join the system 99, by navigating pages of the user interface 212 to provide selections for inviting already identified second users or to otherwise supply contact information used by the system 99 to invite additional users by the user of the system 99.

It is also recognised that in operation of the system, recommendations of services 90a,b,c,d to the user (e.g. benefactor type) can be based on data contents of the user profile 101 associated with two or more user types (e.g. benefactor and beneficiary). In this manner, the recommended services 90a,b,c,d by the system 99 operation can be of benefit to both the first user type and the second user type. One example of recommended service 90a,b,c,d could be a first mortgage service recommended to the benefactor user when the system determines that the associated (with the benefactor) beneficiary user is of an appropriate age (based on demographic data) and stage (based on financial data) for buying their first home. It is also recognised that a user can be determined by the system to be of multiple different user types (e.g. both a benefactor and a beneficiary) in the case of multigenerational family relationships known to the system 99.

As further discussed below, the user, once reviewing the supplied services 90a,b,c,d, can then implement actions 103a based on the served content 103 of the services 90a,b,c,d. It is recognised that the actions 103a can be stored as the application interactions 101a in order to amend their user profile 101, as well as used by the system 99 to select from the plurality of services 90a,b,c,d of the service platform 90 to be supplied (e.g. offered to the user via the user device 104) in order for the user to access the respective content 103 of the selected service 90a,b,c,d).

The users of the application 91 can be categorized into the plurality of user types (e.g. three according to the freemium model design). Alternative embodiments of the user types can also include existing institution clients, the non-institution clients (new users who have registered) and free users (visitors). For example, a user could be determined as both a visitor type and a beneficiary type.

For example, as there is no data available on the visitors, also referred to as a “cold-start problem”, there can be less personalization in operation of the system 99. Visitors can browse the application 91 to take advantage of the some of the application 91 partnered free best-in-class curated services 90a,b,c,d. As the boon, the institution can have an exhaustive in-house and third-party partner, hence a visitor can filter these services 90a,b,c,d and land up with their desired services effectively. Application 91 users can also see the ratings of each service 90a,b,c,d on the respective card by other users, as desired.

Further, visitors and non-institution clients, can get started by creating an account with the application 91 using their demographic data 101c along with a gamified non-invasive questionnaire (results 303—see FIG. 3), which is dealt as the “semi-cold start problem”. Sign up can be a way for the application 91 to engage new clients, understand their life stage 300, provide best-in-class services 90a,b,c,d at the right time of their life and increase the likelihood of client retention by the institution. A gamified questionnaire can be used to derive the current life stage 300 of the user based on the questionnaire results 300, in order to provide more personalized services 90a,b,c,d from the service platform 90. As such, there can be a plurality of different categories of the data 101a,b,c,d associated with the profile 101, such as for example categories of data are used as input to the recommendation engine 54b, such as but not limited to: User Transaction Data (used to predict life events), Life Event Data which indicates specific Needs and Jobs to be Done to meet the needs, Profile Data/Demographics, Survey Data from the User questionnaire and User Behavior and Usage Data collected by the system 99 when the user is using/interacting with the application 99. Further, user types can be defined by the roles (e.g. Benefactor, Beneficiary) and can also be defined by the persona (demographics) and generation characteristics (e.g. millennial, Gen X, Gen Z, baby boomer, etc.).

In view of the above, for semi-cold start problem, the user behavior and usage data 101a within the application 91 is stored to provide better personalization when they return. In addition, the content-to-content filtering algorithm 57a is used to recommend 302 the list of similar services 90a,b,c,d to the one that was chosen previously by the user for better user experience and show the variety of similar available services. For premium existing institution clients (an embodiment of user type), transactions data 101b can be leveraged by the system 99 to build an immersive user experience recommendation by combining with the state-of-the-art machine learning algorithms of the recommendation engine 54b and the life event predictor 54a. Further, based on the extensive user research, it is understood that there is a vacuum when it comes to financial jargons and the need for financial education. Hence, the smart guide 54e is used by the user for providing financial education and recommending the relevant services 90a,b,c,d by the recommendation engine 54b based on the searches performed by the user when using the smart guide 54e.

In view of the above, there can be multiple categories/types of users and recommendations, such as but not limited to: 1) Cold Start—Visitors which involves no to little personalization but can browse and search through the home page to find the most relevant services; 2) Semi Cold Start—Visitors which involves those who have signed up and can leverage questionnaire data 303 to understand the life event 300 and provide matching services by the recommendation engine 54b along with content-to-content 57a similarity (and/or collaborative 57b similarity) based on user behavior 101a and preferences 101a collected within the application 91 based on user interaction with the consent 103 served on the user interface 212 by the microservices 54 in conjunction with the services 90a,b,c,d selected (by the user and/or by the system 99) during operation of the application 91; 3) Warm Start—institution clients which involves personalized service recommendation 302 based on the life event 300 derived from exclusive institutional data 101b, 101c. Like semi-cold start, the application 91 can recommend content-to-content 57a similarity (and/or collaborative 57b similarity) for the prediction 302, based on user behavior 101a for enhanced user experience. It is recognised that the prediction 302 based on real-time user activity 101a can be performed subsequent to the initial prediction 302 provided in response to use of data 101 other than the data 101a.

Further, each of the user types can also be identified/determined by the system 99 (based on the collected user profile data 101 and/or user interaction data 101a) to have other associated user types (e.g. benefactor, beneficiary, etc.). For example, a user identified by the system to be of a specified age and stage (reflected in transactional data 101b and demographic data 101c) can be labelled by the system 99 as a benefactor, a beneficiary, etc. In this regard, the system 99 can advantageously seek to link users of different types with one another, as reflected by content of the user profile data 101 of each respective user, e.g. benefactors linked with one or more beneficiaries, a beneficiary linked with one or more benefactors, a beneficiary linked with one or more beneficiaries, etc.).

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code (e.g. service platform 90, microservices 54, user interface 212 embodied as the application 91, etc.) for execution at runtime by the processor 202; non-volatile storage 208, which stores the computer program code executed by the RAM 206 at runtime; a display controller 210, which is communicatively coupled to and controls the display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for manipulating the user profile 101 and application interactions 101a, such as is described in more detail below. Additionally or alternatively, the servers 108 may collectively perform that method using distributed computing. While the system depicted in FIG. 2 is described specifically in respect of one of the servers 108, analogous versions of the system 99 can also be used for the user devices 104.

One embodiment of the application 91 is configured as a networked application 91 that can assist Baby Boomers and Millennials (e.g. users of the user devices 104) manage life needs from changes in circumstances as they experience different life events in their life journey. The application 91 can be a client-facing mobile friendly application (e.g. as provided by a front end 50—see FIG. 11) that analyzes a user's profile 101 (e.g. transaction data 101b) to proactively predict one's life event 300 by a life event predictor engine 54a and identify associated life stage needs 301 (see FIG. 3). In conjunction with manipulation of the application 91 by the user, the system 99 can apply a machine learning recommendation engine 54b (see FIG. 3) to generate a recommendation/prediction 302 of the Right Services (e.g. 90a,b,c,d) at the right time from a curated platform of services 90 to meet the identified needs 301. The Platform of Services 90 can be curated from best in class institution (holding the user profile 101 and application interactions 101a of the user) and third party partner services 90a,b,c,d to address the identified needs 301 of each identified life event and life state 300. In addition, the application 91 can be used to provide just in time financial education by having a searchable smart guide 54e that can explains complex financial terms in simple language and link the financial terms to associated services 90a,b,c,d in the platform of services 90, as further described below. It is recommended that user interactions 101a (e.g. in selecting offered services 90a,b,c,d as well as/or selecting smart guide 54e content) can be generated (and identified by the application 91) and then used by the system 99 to generate further recommendation(s)/prediction(s) 302 of the services 90a,b,c,d available, for example, in the platform 90.

As further described below, the application 91 can be provided by the system 99 as a user centric tool made for institution and non-institution clients to assist users in managing their needs 301 as they navigate through life's events 300 by offering the right services 90a,b,c,d at the right time. With the overwhelming number of services flooding the internet, the application 91 advantageously connects users with the right services 90a,b,c,d at the exact moments they need it. Leveraging a Life Stage model 55, the application 91 uses any or all of the transaction data 101b and demographic data 101c (from institution clients), and/or questionnaire data 101d (e.g. from non-institution clients) to understand which life event and life journey phase 300 the user is currently in or will be in the near future. Further, the application 91 toolbox can contain trusted in-house and third-party services 90a,b,c,d that users can utilize with confidence, as provided by the recommendation engine 54b. These services 90a,b,c,d can extend from “traditional” banking and offer a variety of useful applications for financial services, expense management, health and wellness, care giving, travel, and retail shopping, as examples only. A personalized dashboard of services 90a,b,c,d can be curated for each user (as displayed by the application 91 on the user interface 212—see FIG. 2) through one or more Service Matching Model (SMM) of the recommendation engine 54b, also further discussed below by example operation, which can inhibit the task of navigating the general internet 102 for the correct services 90a,b,c,d by the user.

The system 99 can utilize a variety of technological services, features and applications in order to analyze the user profile 101 and application interactions 101a, as well as to offer services 91 from the service platform 90, as provided by example above. For example, referring to FIG. 11, the system 99 can be configured to include a frontend platform 50 and a backend 52 accessed by a gateway 53. The backend 52 can be used to provide, via the application 91, a variety of microservices 54 in order to provide a more organized and decoupled backend platform 52. The example backend microservices 54a,b,c,d,e can be such as but not limited to the life event predictor 54a, service recommendation system 54b, service detail provider 54c, user authentication 54d, and the get smart guide 54e.

For example, the user authentication 54d microservices can handle application 91 account creation, login and json web token authentication. This service 54d can provide secure account management and authentication methods via Apigee, for example, facilitating users to register new accounts and maintain their data over multiple sessions, while providing authentication and encryption of user information 101, 101a stored in MongoDB.

The service recommendation engine 54b can provide recommended services 302 based on stored user information 101, 101a through its connection with the data science models 59 that are hosted with flask and S3, for example. Through the use of this model 59, the frontend 50 can continue to provide data (e.g. user interactions 101a) to the models 59 in order to make the recommendations 302 more accurate, and request new recommendations 302 both for individual users, and for a content-based matching algorithm 57a and/or a collaborative-based matching algorithm 57b and used to display similar services 90a,b,c,d when in the service details page of the application 91 on the user interface 202, as further described below.

The service information 54c microservice is used to retrieve specific details about the services 90a,b,c,d available with application 91, as predicted/recommended 302 by the recommendation engine 5b. This microservice 54c can be decoupled from the service recommendation 54b microservice in order to facilitate scalability and provide for the case where service information can be obtained without having to involve the data models 59 or any sort of recommendations 302. This microservice 54c can be heavily integrated with the stored service information of the services 90a,b,c,d in MongoDB (e.g. implementing the service platform 90), and can act as a bridge to serve specific tailored information from the database based on frontend 50 requests via the gateway 54.

The get smart guide 54e can also be integrated with the data models 59 and can act to provide users with the results from any questions (e.g. search queries) they have asked through the Get Smart Guide 54e, and the services 90a,b,c,d relevant to their search.

Referring to FIG. 4, the recommendation engine 54b algorithm can be implemented using technology such as but not limited to Public Python Libraries (e.g. Scikit Learn, Pandas, Numpy, NLTK, Collections, Matplotlib, Seaborn, radar, boto3, imblearn, XGBoost, tqdm, botocore, pyyaml) and machine learning algorithms such as but not limited to: XGBoost Machine Learning Model with SMOTE to handle the class imbalance and feature importance using Random Forest algorithm to select the most important features and feed to the model 59 to predict a user's life event 300 by the predictor 54a; K-Means Clustering algorithm with NLTK data descriptive analysis along with Google Gensim word2vec model to cluster the institution in-house and third party partnered services 90a,b,c,d into k clusters for content-to-content recommendation via the model 57a in order to predict 302 a selected set (e.g. top 5) relevant services 90a,b,c,d. K that can be chosen with Elbow analysis followed by Silhoutte analysis; and Cosine similarity scoring function with NLTK data descriptive analysis along with gensim word2vec model for an optimized financial glossary search engine for the get smart guide 54e.

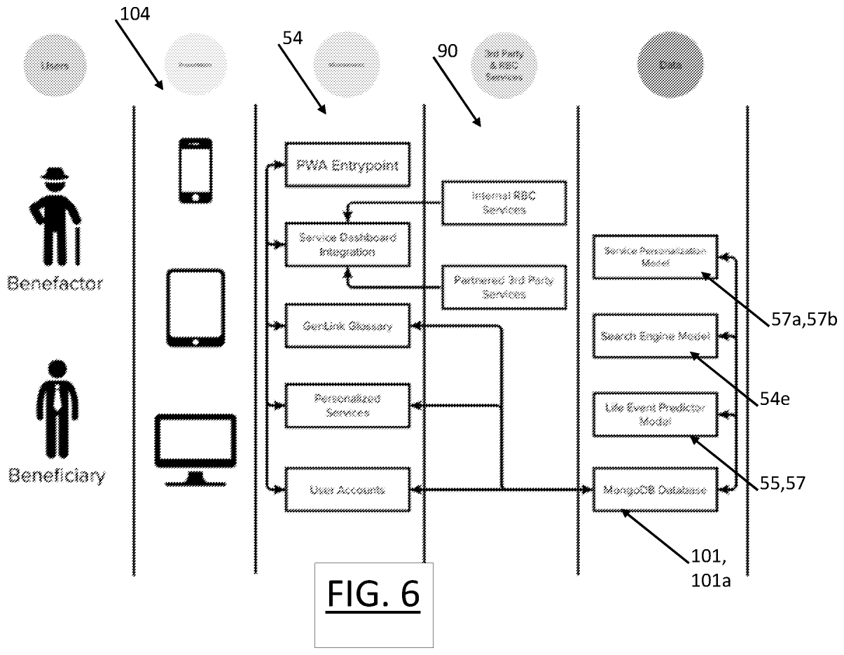

Referring again to FIGS. 3 and 4, example methodology followed by the system 99 can include the life event predictor models 55, 57 used to identify the current life event 300 leveraging the client's transaction, mortgage, investments and the line of credit data (e.g. data 101b) and/or the demographic data 101c. For example, the retirement predictor model 55 is solved using the data 101 (e.g. the last 3 months transactions, investments, mortgage, line of credit details along with unique retirement goal, time to retirement goal of the user). For example, having a baby predictor model 57 is solved based on data 101 (e.g. the last 3 months transactions, transaction types such as child care, pharmacy, toys, baby apparel, women apparel, baby gear, etc.). It is recognised that the models 55, 57 can be other than as shown, as well as different types as shown by example only. Referring to FIG. 6, shown is an example logic layer diagram of the system 99 of FIG. 3.

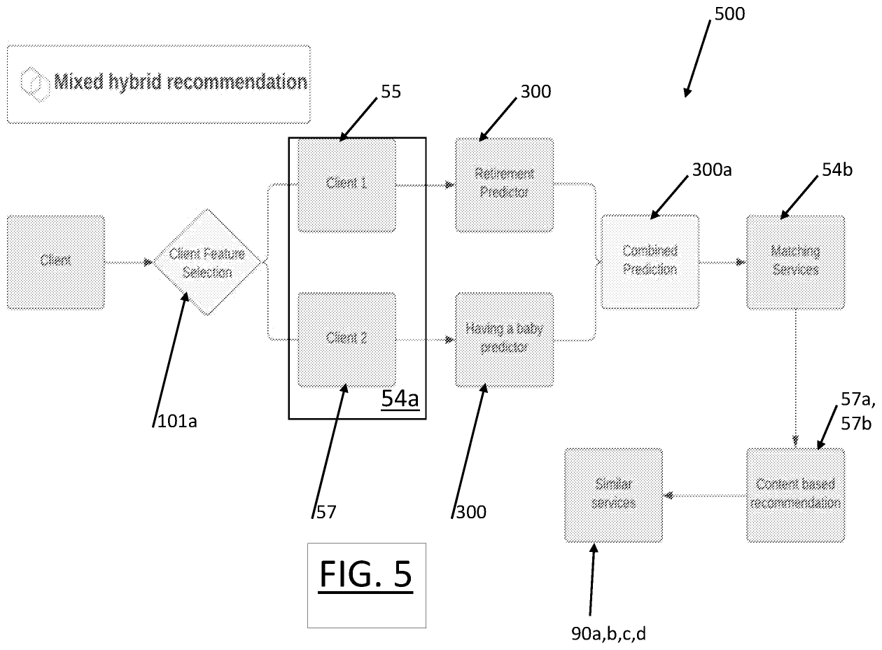

Further considerations for generation of the event stage prediction 300 can include: 1) a cold start case for the recommendation system 54b where there is limited to no information (e.g. data 101) about the user. This cold start case is solved by using life events defined through a gamified questionnaire (e.g. set of queries 303 posed to the user on the user interface 212 via the predictor 54a) to understand the client's current life stage; 2) Clustering of the institution's partnered and third party services 90a,b,c,d using K-Means Clustering with ELBOW and silhouette analysis to identify the right K; a combination of life event predictor model 54a along with the content-to-content similarity and service matching model 57a based on life event labels that can return contents 103 from various sectors based on user preferences (e.g. leveraging application interactions 101a); 3) combining user preferences 101a with user behavior 101a within the application 91 (e.g. services 90a,b,c,d chosen) for manipulation by the content-to-content filtering algorithm 57b; 4) combining the architecture of mixed hybrid recommendation system 500 (see FIG. 5) with a cascade recommendation system in which the output of a plurality (e.g. a pair) of life event predictors 300 by the event predictor 54a is made (using the different models 55, 57) as a combined input 300a to the service matching (implemented by the recommendation engine 54b) which is based on user preferences 101a; 5) batched training of Life event predictors 300, Content based filtering 57a, collaborative filtering 57b and/or Smart guide 54e with new data 101a collected in response to user activity in the application 91 in pre-defined intervals; and 6) diversity in content 102 displayed to users to inhibit repetition by adapting user behaviors of selecting services of interest (e.g. via monitoring of the application activity 101a). IT is also recognised that the recommendation engine 54b and the event predictor 54a have access to datasets such as but not limited to: institution in-house and third-party partners services dataset (e.g. profile data 101); Life Event Predictor Model's 55, 57 dataset (e.g. Retirement model dataset, having a baby model dataset, etc.); and/or a Glossary for Financial terms dataset incorporated in the get smart guide 54e.

Referring to FIGS. 3, 4, 5, the mixed hybrid recommendation system 500, as an embodiment of the system 99, can be implemented as follows. The first stage of the recommendation engine 54b is to identify the life stage 300 of a person/user using the profile data 101, as well as for example any life event/stages 300 of associated/linked user types (e.g. of the first user such as an identified benefactor—beneficiary relationship between the first user and the second user as reflected in the user profile data 101). Based on the life event 300, a set of relevant services 90a,b,c,d can be predicted with using the profile data 1010 and/or user preferences 101a (also referred to as historical interactions, application interaction, etc.). The system 99 can use client's demographic 101c, historical interactions 101a, last three-month transaction history (e.g. transaction data 101b) optionally coupled with unique retirement plan and time to achieve retirement plan as features. For non-institutional clients, the application 91 can use the questionnaire results 303 to identify the life stage 300. Example life events/stages 300 can be as follows (which have matching services 90a,b,c,d as mapped via the recommendation engine 54b): First Job—Entertainment, Electronics & Digital, etc.; Job Loss—Job Aggregators, Skill development platform, etc.; Getting Married—Apparels, Aggregated Retails, etc.; Having a baby
Baby Accessories, Baby Gear, Finance, etc.; Retirement—Health & Wellness, Finance, Travel, Executor services, etc.; and Caregiver—Health & Wellness, Aggregated Retail, etc.,

For example, retirement stage 300 can be an initial revelation, understanding retirement possibilities, adjusting lifestyle, less financial flexibility, enjoying retirement but missing work life, slowing of pace. For example, having a baby stage 300 can involve considering the possibility, preparing for parenthood, expecting a child, stress as a new parent, bliss of a new child, enjoying life with new extended family. Based on the specific life phase of the client's life stage 300 and historical client preferences 101a, an intuitive way of service matching is performed by the recommendation engine 54b to offer the clients with best-in-class services at the right time.

For example, the application 91 can use the novel mixed hybrid recommendation system 500 where the life stage recommendation 300 is performed in parallel for a first user and an associated second user (of the user profile 101) using multiple models 55, 57 (e.g. a pair of models, however recognizing that more than two models can be used at any one time in generating the combined prediction 300a), such as both retirement 55 and having a baby model 57, and the individual model results 300 and combined model results 300a (e.g. user is determined to be relevant to both retirement and having a baby) are cascaded as input the service matching 54b, which acts as the input for content-to-content filtering 57a (and/or contrastive filtering 57b), see FIG. 5.

In the service matching algorithm 54b, a set of services 90a,b,c,d are recommended to the user, which can be based on the historical user preferences 101a as well. In a long time period, based on the user's feedback through ratings, user behavior of viewing, choosing the services, change of user's life stage the type of services offered can be altered in order to recommend services by sampling from various identified life stages 300. For example, a person whose currently in having a baby life stage 300 could potentially also move to a caregiver stage 300 or job loss life stage 300.

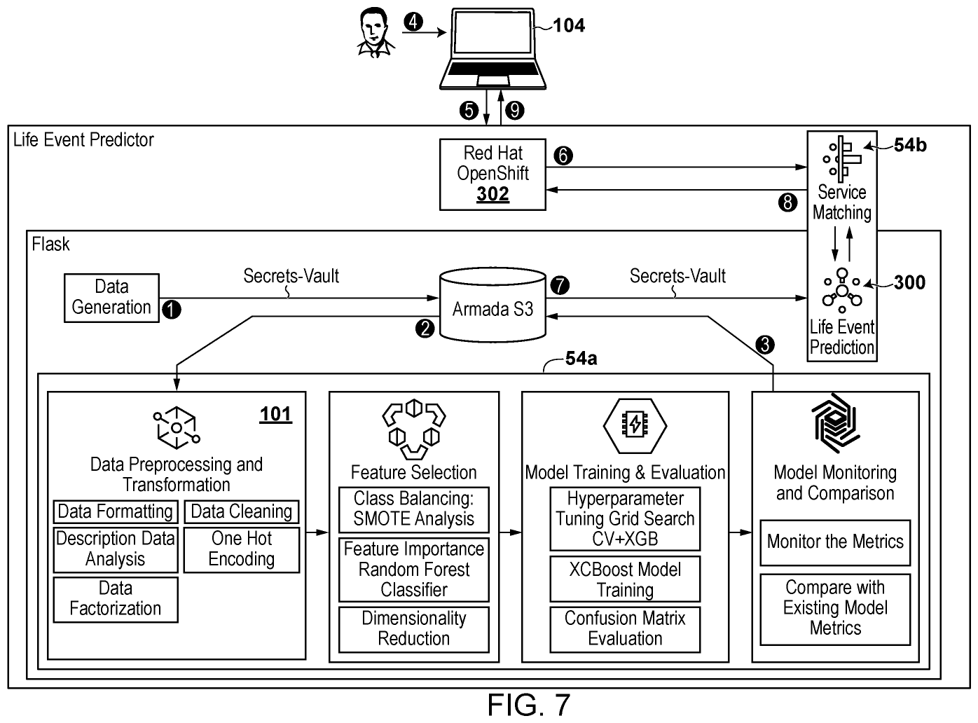

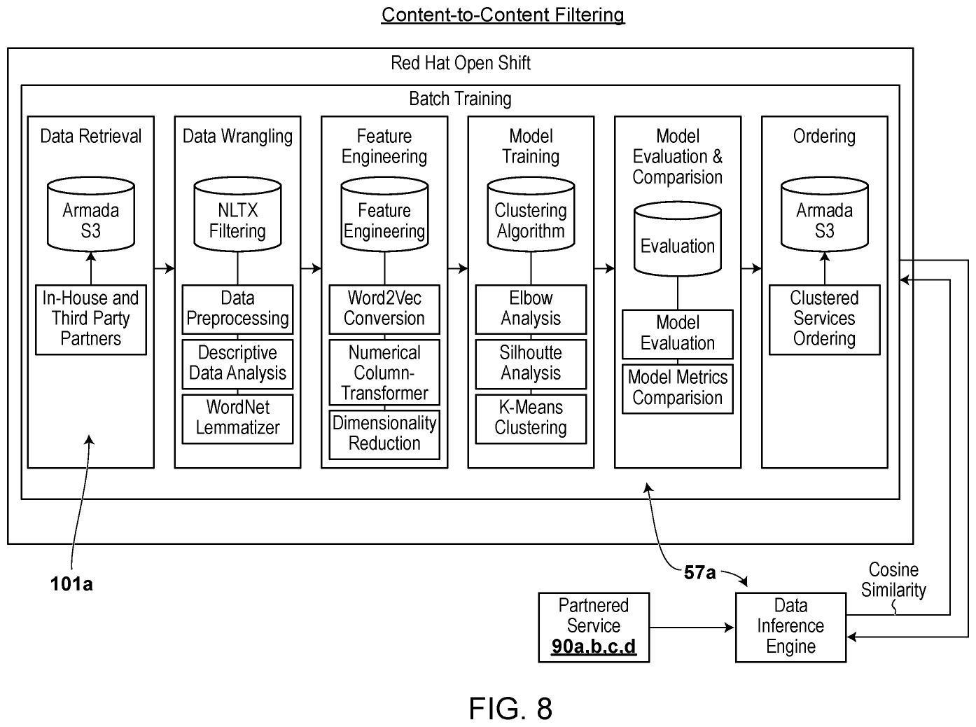

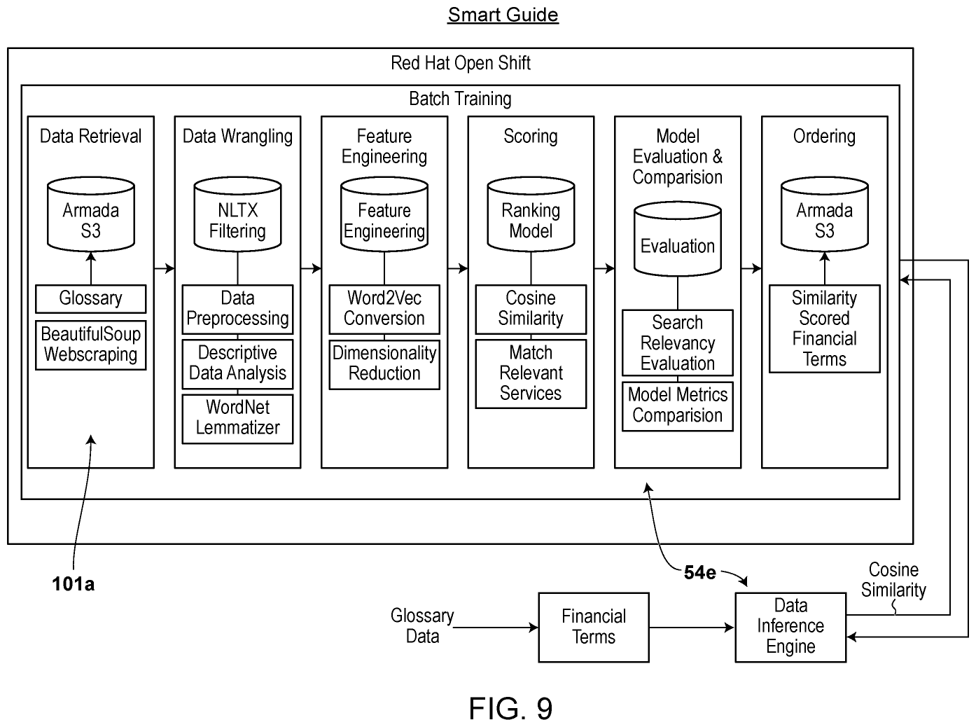

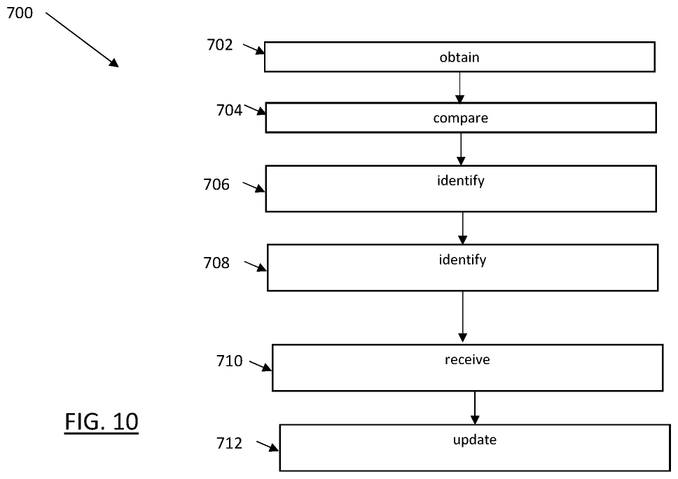

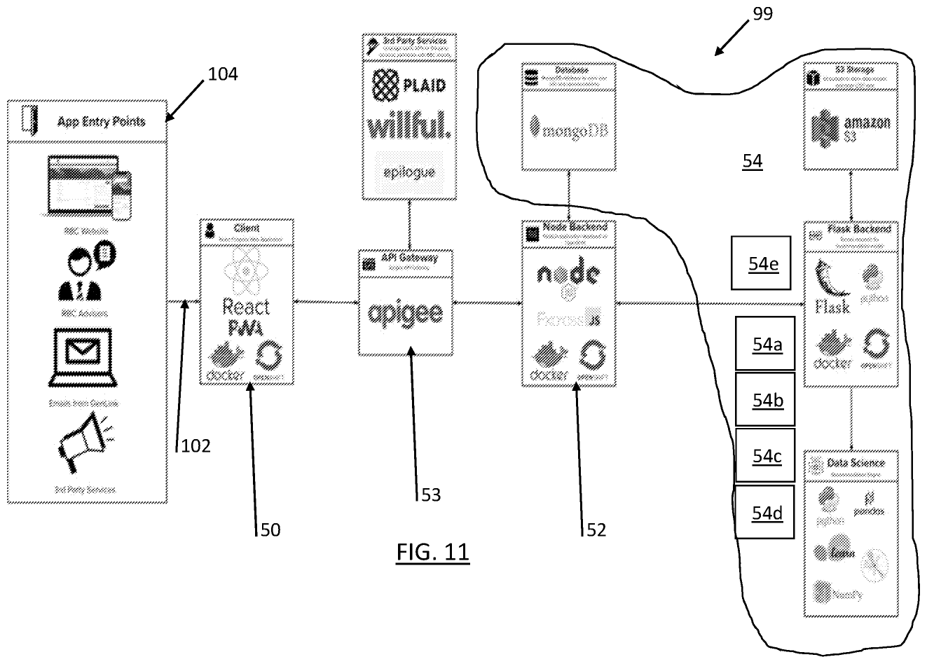

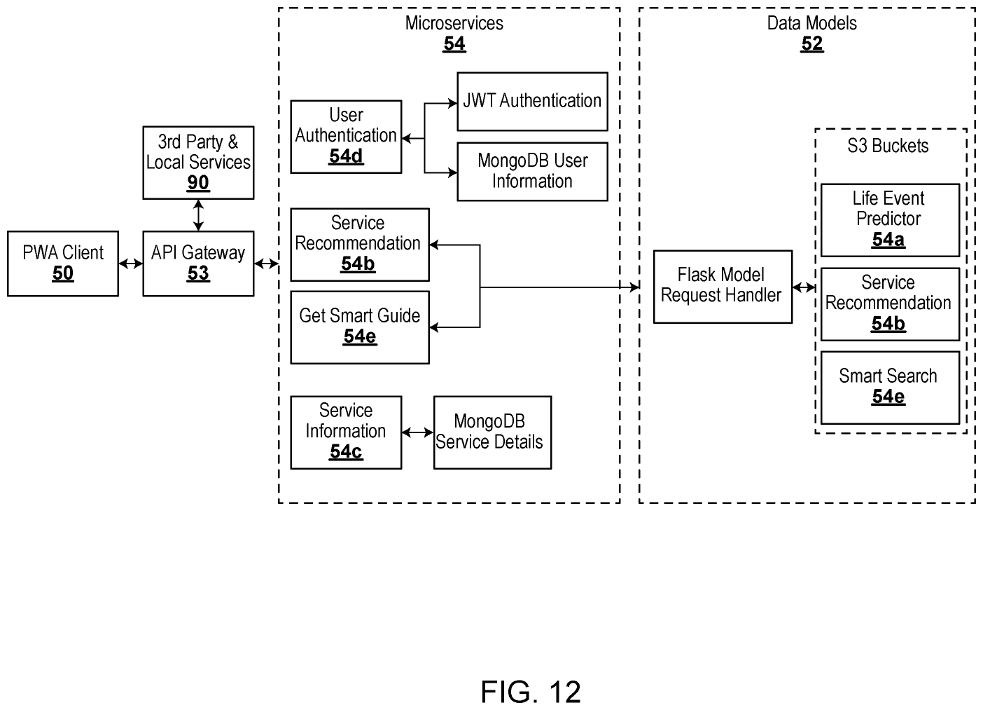

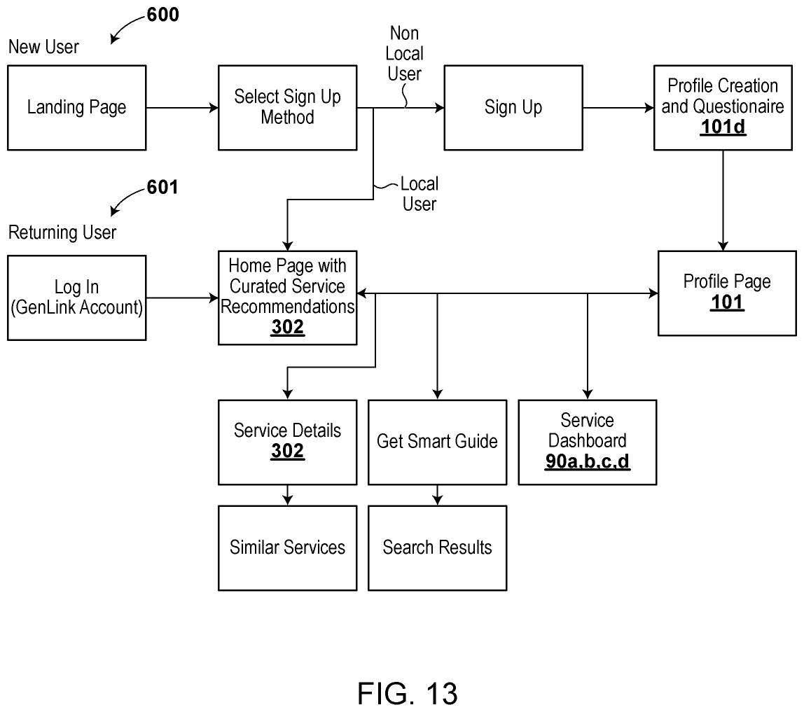

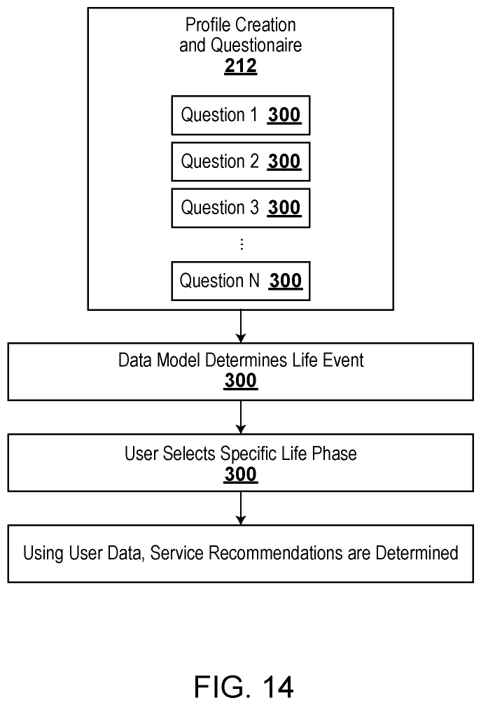

Referring to FIG. 7, life event predictor 54a is one of the modules associated with of the application's 91 recommendation system 54b (e.g. operated as a hybrid system—see FIG. 5). As discussed, the application 91 can have a plurality (e.g. one or more pairs) of life event predictor models 55, 57, one for predicting retirement 55 and other one for predicting whether a user is going to have a baby or not 57. A machine learning (ML) pipeline can be used for generating the life event predictor results 300 is as follows. The ML pipeline can consists of components namely Data preprocessing and transformation, Feature selection, Model Training & Evaluation and Model monitoring and comparison. For data preprocessing and transformation, the clients' data 101 is imported from S3 using credentials stored as part of Vault. The incoming data 101 is cleaned, formatted, dropped similar data points, performed one hot encoding for categorical columns and factorization for numerical columns. For feature selection, in general, since the number of people retiring or going to have a baby (examples of stages 300) are more or less in number compared to the whole population distribution, there can exist a class imbalance issue. Hence, the application 91 can use SMOTE analysis to balance classes by performing oversampling yet maintaining a similar distribution, so that it represents the actual ground truth. Feature importance can be performed using Random Forest Classifier as it can help in identifying non-linear relationship between features and target variable. Then, it can be plotted as a barh graph using matplotlib with descending values, which is used to perform visual analysis and set a threshold where the values drop massively. In addition to this, dimensionality reduction is can be performed using correlation matrix to identify the topmost important features. For model selection, training and evaluation, the application 91 can use multiple models like Logistic Regression, Decision Tree and XGBoost, compared their metrics and finally chose XGBoost as the ML model. XGBoost can add trees to the algorithm until there is an improvement in the metrics and stops when there is no betterment. Hyper parameter tuning can be performed using grid search CV and XGB Classifier with ‘recall’ as scoring to identify the right weights to be used as this is an imbalanced class, thus not giving importance to specific features which eventually will affect the prediction. Finally, the model 55, 57 is evaluated by considering the recall value in the confusion matrix as False negatives are considered to be more important in this scenario. In terms of model monitoring and comparison, according to the batch training architecture, once sufficient amount of new data is collected, the model can be trained. In order to have the best model in production, we can do monitoring for model 55, 57 performance with sample data and compare the existing model 55, 57 with new model metrics and is pushed into production only if it performs better than the previous model. The generated data and models can be stored in an S3 bucket. The S3 bucket's secrets are stored in Vault and imported as OS variables when accessing it.

In view of the above, during operation of the application 91, once the institutional user signs in, an API call is made from the backend microservice 54 to the data science microservice 54 with the appropriate API endpoint through APIGEE with the institutional user ID. The user's data 101 is fetched with the ID and data transformation is performed. Then, the life event prediction model 55, 57 is triggered with this transformed data. The predicted value 300 can be used to match and fetch services 90a,b,c,d as per history of user preferences and services used by similar users (e.g. using content and/or collaborative filtering 57a, 57b).

For example, in reference to FIG. 8, content to content filtering 57a can be employed in order to offer a smoother user experience and personalization, which can be advantageously tailored to users interests (e.g. reflected in data 101a). The content based filtering algorithm 57a is used to provide similar contents 103 (of the services 90a,b,c,d) at the right time. The content filtering 57a uses similarities in products, services, or content features, as well as information accumulated about the user by monitoring their behavior 101a within the application 91 to make the recommendations 302. In this regard, the system 99 can first make a recommendation 302 based on the user profile data 101 and can then make one or more further recommendations 302 based on use of the user data 101a (e.g. interaction with the smart guide 54e— see below).

The ML pipeline can be used to build a content-based filtering algorithm 57a containing a number (e.g. 5) components is as follows: 1) Data 101,101a retrieval involving the institutions in-house and third party partnered services data along with its industry and sub-industry; 2) Data Wrangling involving data preprocessing which can include combining of the industry and sub-industry of services into single feature, stop word and punctuation removal using NLTK libraries and performed WordNet Lemmatization; 3) Data Engineering involving the numerical column which contains additional information as converted using ColumnTransformer, such that the selected features can be combined and converted into vectors using Gensim and Google News Negative pretrained word2vec pretrained model which contains 300-dimensional vectors for 3 million words and phrases, which is currently the largest corpus; 4) Model Training involving the word2vec converted features can be clustered using K-Means clustering algorithm to combine similar services together, for example in order to find the right ‘K’, one can perform ELBOW and Silhouette analysis, with the identified ‘K’, the services can be clustered using K-Means algorithm; and 5) Ordering involving the clusters can be assigned back to the services.

In view of the above, during operation of the application 91, when a user interacts with any of the displayed services 90a,b,c,d and selects them, an API call is triggered from the backend microservice 54 to the data science microservice 54 with the appropriate API endpoint through APIGEE with the chosen service name. The service name is matched with the partners data and data cleaning and transformation is performed. Later, the feature is converted into vectors using gensim word2vec model. The engineering feature is as model input to predict the cluster which the service belongs to. Once the cluster is identified, in order to provide more accurate and relevant services, we have performed cosine similarity cost function. At this point, the recommendation 302 is provided for use in selection from the services platform 90 for the service(s) 90a,b,c,d best matching the recommendation 302. It is also recognised that in view of available users and user interactions data, the recommendation engine 54b can offer collaborative filtering 57b and recommend users with services 90a,b,c,d which are used by users with similar interests to the user employing the application 91.

Referring to FIG. 9, the smart guide 54e incorporates a smart search engine for financial education, that provides meanings and definitions for financial jargons and recommend the relevant best-in-class services 90a,b,c,d based on the search. It is recognised that users of various age groups can be unaware of most of the financial jargons such as benefactor, beneficiary, estate planning, executor services, etc., Hence, advantageously the application 91 includes a smart guide 54e which can provide meaningful explanation on the financial jargons that are searched (e.g. user interactions 101a with the smart guide by searching for and selecting one or more terms from the glossary data) along with suggesting relevant services 90a,b,c,d, based on manipulation of the user interactions 101 with the smart guide 54e via the user interface 212 of the user device 104. The smart guide 54e can utilize Google's gensim model with NLTK descriptive data analysis coupled with cosine similarity to fetch the accurate definition. The model can be trained on the institutions (e.g. financial) glossary terms and can be extended to most of the (e.g. financial) jargons available across the (e.g. banking) institutional domain. For example, the glossary data can contain a comprehensive list of wealth transfer terms with definitions in simple language, for search and use by the users in order to more fully understand the role, processes, and products related to wealth transfer 300, or other life stage events 300 as desired. Links to services 90a,b,c,d to further educate users can be provided alongside the definition provided in the user interface 212. Used/accessed terms in the smart set guide 54e by the user (therefore generating user data 101a) can be used by the system 99 to identify/match those same terms also associated with selected services 90a,b,c,d of the service platform 90.

In view of the above, the models 55, 57, 57a,b, 59 used by the system 99 (e.g. which can be referred to as a personalization engine) can be employed by the application 91 to offer the best-in-class personalized recommendations 302 of the services 90a,b,c,d based on the profile data 101 known about the users and user behavior/preferences data 101a marked by viewed, searched and selected content 103 within the system 99. This can be provided by machine learning (ML) algorithms like XGBoost, Natural Language Processing (NLP) algorithms like Gensim coupled with cosine similarity cost function. Accordingly, the application 91 can recommend 302 a variety of services 90a,b,c,d based on the previous clients' preferences 101a within the application 91. In terms of diversity, it is facilitated that a range of services 90a,b,c,d can be recommended without tampering the content similarity, as discussed by example above.

Based on various life events 300 identified by the life event predictor 54a, the personalization of the user can be crafted in such a way that it meets the needs of user's specific life stage(s) 300 as identified. In the case of visitors, they can browse through the application 91 and get to know the diversity of services 90a,b,c,d available. It is noted that the application 91 may not store any information, nor have any prior data 101, 101a on the visitors. Hence, there may be no personalization performed for such users. For non-institutional users who decide to sign up with application 91 with their demographic details 101c, the application 91 can provide with a gamified non-invasive questionnaire to collect queried results 303 in order to improve user experience and understand the life stage 300 of the user. Based on the life stage identified 300, to make the personalization extremely granular, the application 91 can list several life phases specific to each life stage 300 which was identified as part of user interviews with people across age, advisors and brokers. Service recommendations 302 can be provided to new application 91 users based on the life phase 300 from questionnaire results 303. In addition, these new users can be provided with similar services 90a,b,c,d to the one they choose based on content-to-content filtering 57a as discussed above. For premium institutional clients, the application 91 has access to their transactions data 101b as part of their profile data 101, which can be used by the application 91 to identify the precise current life stage(s) 300 of the user, coupled with optional gamified life phase identification, to help provide accurate personalized service recommendations 302. Institutional clients can also be provided with similar content 103 based on their previous selections 101a through content-based filtering algorithm 57a implementation as provided by example above.

In terms of the availability of various types of data for the various models 55, 57, 57a,b, 59, the application 91 can be configured as follows. For life event prediction models 55,57, the application 91 can use client's demographics 101c, transactions 101b, investments, mortgage, line of credit, retirement goals, and/or time to achieve retirement goals data, which can preserve the actual relationship and distribution of real institutional user data, for use in the life event prediction 300. In the case of content-based filtering 57a, the application 91 can use institutional in-house and third party partnered services dataset 101 and use the Glossary of financial jargons data set for smart guide 54e. Using these data sources, the application 91 can be implemented to recommend highly personalized content 103 leveraging ML and NLP algorithms of the associated models 55, 57, 57a,b, 59.

In having access and manipulation of the data 101, 101a, the recommendation engine evaluation 54b can be performed in a variety of ways, as desired by the configuration of the system 99, in particular in view of the classification(s) (e.g. life event 300) of the user. In this regard, it is recognised that model evaluation can be an integral part of the model development process. The evaluation criteria can be focused on the content relevance and variety during content based filtering, on-point definition and displaying relevant services for smart guide search and predicting the right life event of the clients. In the case of life event prediction, which is a classification problem, predicting the retirement and having a baby life stage event of clients who are actually falling in the respective category is relevant. Hence, false negatives are crucial. A great approach to assess this scenario is through considering the recall value of the confusion matrix. The life event predictor model 54a employed by the application 91 has a recall value of 94% for the data set 101, 101a used. The application 91 employs the K-Means clustering model combined with the cosine similarity cost function for the accurate and better prediction top N recommended services 90a,b,c,d that is similar to the one the user has already chosen (e.g. as represented by the user data 101a identified by the system 99 during use of the application 91 by the user). For evaluating K-Means clustering, the application is configured by performing: calculation of spatial distance between centroids; and Lowes distance ratio.

Further, based on Elbow and silhouette analysis performed on institutional partnered services 90a,b,c,d, the application 91 can have (e.g. 4) clusters and have a spatial distance between centroids of 0.88 and 92% confidence score as per lowe's distance ratio. For evaluating the recommendation 302 of similar content with diversity, the 1-cosine similarity can be performed, among the various user's list of recommended services but belonging to the same life event 300 such that the possibility of ending up with same list of services is high. We considered a top set (e.g. 5) recommendations for dissimilarity measure between (e.g. 5) similar users and resulted with an average of 25% similarity. On the other hand, for users' personalization experience, recommending unique services that best fits the user's life stage with diversity is measured with a high score of ranked intra-document dissimilarity. According to a number of user interviews and research, we understood that the pain points and needs for each life stage is different. For the same set of users, we measured an average intra-document dissimilarity of 80% which shows that even in the list of recommendations, there contains diversity to reduce the factor of repetition and keep the user engaged with better user experience and retention. However, one of the most popular and an effective way to assess the performance of personalized recommender system is to carry out an A/B testing by target users of the system. We do have a rating feature on our roadmap for users, where they can rate the services recommended along with their experience with smart guide for its financial definitions. Thereby we collect the feedback, analyze the user behaviour within the application and re-iterate the system if need be.

As described, the profile data 101 can include age, profession, geographical location, institution products selected by the user, etc. For example, the profile data 101 can contain all financial data concerning bank accounts, credit card transactions, and investment data of an institution. One embodiment of the service 99 and application 91 operation is as a financial accounts explorer/facilitator/advisor for the user, based on the user profile data 101 and the application activity data 101a. For example, the application 91 can be an institution (e.g. RBC) Launch app. For example, the data 101 can include an aggregation of proprietary RBC data representing different RBC products (e.g. bank accounts information, reward points information, investment information, credit card information, etc.). In view of the above, it is recognized that communication between the user (via the device 104) and the system 99 can be synchronous or asynchronous communications 50, as initiated by the user and/or the system 99.

Referring to FIG. 10, shown is an example operation 700 of the system 99 (of FIG. 1) for operating the application 91 based on user profile 101 data and/or user interaction data 101a.

For example, applying the user profile data pertaining to a user of a network system 99 of the institution for providing services 90a,b,c,d to a user from a platform of services 90. For example: obtaining 702 user profile data101 pertaining to the user of a network system 99 of an institution; comparing 704 the user profile data 101 to a plurality of different potential life stages 300 in order to determine a selected life stage 300, 300a; identifying 706 one or more services 90a,b,c,d from the platform of services 90 based on the selected life stage 300, 300a; identifying 708 the one or more services 90a,b,c,d to the user via a user interface 212 of a user device 104; receiving 710 a request 103a from the user through the user device 104 for access to the one or more services 90a,b,c,d; and updating 712 contents of the user profile 101 to include or otherwise be associated with additional profile content 101a related to activity 103a of the user with the one or more services 90a,b,c,d.

Tech Stack

Referring to FIG. 11, the system 99 can utilize a variety of technological services, features and applications in order to analyze the user profile 101 and application interactions 101a, as well as to offer services 91 from the service platform 90, as provided by example above. For example, referring to FIG. 11, the system 99 can be configured to include a frontend platform 50 built as a Progressive Web Application (PWA) 91 aimed to maintain responsiveness, while also providing users with the ability to use portions of the app 91 offline (browse available services 90a,b,c,d). The PWA app 91 can mitigate the additional task of having to download an app from an app store and can also facilitate easy deployment of the app 91 by linking to multiple institution and third party websites (e.g. an example of the service platform 90). Further, the PWA platform can facilitate the application 91 to provide the variety of services 90a,b,c,d spread over a set of core pages, with each page providing an independent and meaningful feature, as an illustrative example only. For example, included can be; React PWA—Core UI Framework, Redux—State Container for React PWA, React Router—Routing Library, Styled Components—CSS Styling Library, and Jest—Frontend Testing Framework. Additionally, a backend 52 of the system 99 can be accessed by a gateway 53. The backend 52 can be split into a variety of microservices 54 in order to provide a more organized and decoupled backend platform 52. The example backend microservices 54a,b,c,d,e can be such as but not limited to the life event predictor 54a, service recommendation system 54b, service detail provider 54c, user authentication 54d, and the get smart guide 54e. The microservices 54 can be supported by systems such as but not limited to; Node.js—JavaScript runtime, Express—Web Application Framework, MongoDb— Database, Mongoose—Mongo Query Builder, Jest—Backend Testing Framework, JsonWebToken—User Authorization Tokens, and Bcryptjs—Password Encryption, for example. Further support can include DevOps services such as but not limited to; Docker, OpenShift, GitHub, Helios, Vault, and Apigee. Further support can include Data Science services such as but not limited to; Language—Python 3,IDE—Jupyter, Anaconda, Statistical tools—Numpy, scipy, imblearn, Visualization—matplotlib, seaborn, Frameworks—Pandas, boto3, Scikit-learn, XGBoost, API Framework—Flask, and Database—Armada S3, Mongo.

The example tech stack shown in FIG. 11 leverages the microservices 54 by utilizing a variety of dockerized container microservices for solution robustness and scalability. For example, each microservice 54 can have its own exposed endpoints, thus facilitating utilization of individual services when needed (life event predictor 54a, etc.). In terms of security, protected resource access can be authenticated through the use of JSON Web Tokens, so private pages are protected, and only authorized users can access the application 91 content 103 relevant to them. User passwords can be hashed, and the encrypted values are stored in MongoDB. Further, user authentication can be handled through the use of JSON Web Tokens (JWT) to authenticate users, and user information is encrypted and stored in MongoDB. Alternatively, user authentication and security can be handled through authentication methods with Apigee that meet institutional security standards. In terms of user experience, the PWA React App 91 can be used to facilitate responsiveness across a variety of devices 104, along with facilitating the creation of simple, reusable components throughout the frontend 50. For data (e.g. 101, 101a, etc.) MongoDB can be utilized to store user account information and recommendations, along with service details. This can facilitate a flexible NoSQL schema that can support scalability and ease of use. S3 can be used to store the data models 59 and help provide real-time prediction 302 with client's input 101a because it can be highly scalable and facilitate the flexible storage of intermittent CSV files.

As discussed above, the backend 52 utilizes microservices 54 architecture, that split it up into independently deployable microservice modules 54a,b,c,d,e which communicate with each other through APIs. Each microservice 54 covers its own scope and can be updated, deployed, and scaled independently. Implementing microservice-based architecture can add ease to the process of identifying and resolving the root of performance issues that means our applications 91 can remain unaffected by a single failure. Application 91 security architecture can be built to address different vulnerabilities and to meet industry standards in order to protect institutional client's data and maintain their privacy status. For example, JSON Web Token (JWT) mechanism can be used verify and authenticate application 91 users and store encrypted user information in Mongo DB. Further, the application 91 can use vault as the underlying architecture to store the critical access tokens which can be used to communicate with the S3 bucket for storing the data model 59 and providing real-time personalization. All Data-in-transit can be encrypted for http requests as well. The frontend 50 can be configured as built of React functional components with the help of the Redux toolkit which can provide the ability of the system 99 to manage the state and to pass many props through multiple hierarchies of the components. This can result in an easy to read, to test and to debug application 91 because of plain JavaScript functions without state or lifecycle-hooks. Also, the frontend 50 can use Redux Thunk for communicating asynchronously with an external API to retrieve or save data. Redux Thunk can make it easy to dispatch actions that follow the lifecycle of a request to an external API. The backend 52 can be split into the variety of microservices 54 in order to provide a more organized and decoupled platform 99. The backend microservices 54 can include the life event predictor 54a, service recommendation system 54b, service detail provider 54c, user authentication 54d, and the get smart guide 54e.

Further, the application 91 supports PWA that can operate both as a web page and mobile app on any device 104. The most significant benefits PWA offers can be its speed, the ability to work off-line, and accessibility directly from the browser. The institution clients can add the application 91 to the Home Screen of their mobile device 104 like a typical native app, skipping app stores and saving valuable storage, especially in the situation with poor connection or an expensive data plans. Furthermore, the application 91 provided by the system 99 can be encapsulated into Docker containers, which facilitates the application 91 to be hosted on any Cloud Service Provider.

Referring to FIG. 12, provided is a further embodiment of the system 99 of FIG. 11. Referring to FIG. 13, shown is an example user interface 212 workflows 600, 601 having various screens with data 101, 101d, services 90a,b,c,d and results/recommendation 302. Referring to FIG. 14, shown is a further example user interface 212 workflows having various screens with questionnaire results/content 300.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification. The scope of the claims should not be limited by the embodiments set forth in the above examples, but should be given the broadest interpretation consistent with the description as a whole. It should be recognized that features and aspects of the various examples provided above can be combined into further examples that also fall within the scope of the present disclosure. In addition, the figures are not to scale and may have size and shape exaggerated for illustrative purposes.

1. A method on applying user data for providing services to a user from a platform of services, the method comprising the steps of:
obtaining stored user profile data pertaining to the user of a network system of an institution;
comparing the user profile data to a plurality of different potential life stages in order to determine a selected life stage;
identifying one or more services from the platform of services based on the selected life stage;
identifying the one or more services to the user via a user interface of a user device;
receiving a request from the user through the user device for access to the one or more services; and
updating contents of the stored user profile to include additional profile content related to activity of the user with the one or more services.

2. The method of claim 1, wherein said obtaining of the user profile data is by way of a user generated communication directed to the network system over a communications network.

3. The method of claim 1, wherein said obtaining of the additional profile content is by way of a user generated communication directed to the network system over a communications network.

4. The method of claim 3, wherein the generated communication includes demographic data supplied by the user.

5. The method of claim 4, wherein the demographic data includes beneficiary data describing a second user type of a beneficiary, such that the user is of a first user type as a benefactor, such that the one or more services are associated with the second user type based on the beneficiary data.

6. The method of claim 3, wherein said obtaining of the additional profile content is by way of accessing transactional data associated with the user in order to update the contents of the user profile.

7. The method of claim 1, wherein said obtaining of the user profile data is by way of a network system generated communication previously directed to the user over a communications network.

8. The method of claim 1, wherein the contents of the stored user profile are updated to reflect changes to a financial service of the one or more services, the financial service selected from the group consisting of: a financial transaction; insurance; and a mortgages.

9. The method of claim 1, wherein the additional profile content is used by the system to identify one or more further services from the platform of services and identifying the further one or more services to the user via the user interface.

10. The method of claim 1, wherein the user is a first user of a benefactor type and said updating contents includes user data of a second user type of a beneficiary.

11. The method of claim 1, wherein the user is of a first user type.

12. The method of claim 11 further comprising determining the user is associated with one or more other users, the one or more other users are designated as a second user type.

13. The method of claim 12 further comprising said updating of the contents of the stored user profile includes both content associated with the user of the first user type as well as content associated with the one or more other users of the second user type.

14. The method of claim 13, wherein the first user type is a benefactor and the second user type is a beneficiary, such that the selected life stage is a life event of wealth transfer between the benefactor and the beneficiary.

15. The method of claim 1 further comprising inviting by the user for an additional user to join by navigating pages of the user interface to provide selections for inviting already identified second users or to supply contact information to invite the additional user.

16. The method of claim 1 further comprising sending to the user a recommended service from the platform of services by using the user profile data to identify life needs of a secondary user associated with the user.

17. The method of claim 1, wherein the platform of services is provided by a financial institution, the platform of services managed by data center for hosting online banking services facilitating a plurality of the users to log in using respective user accounts providing access to various computer-implemented instances of the online banking services.

18. A computer system for manipulating and maintaining a user profile including applying user data for providing services to a user from a platform of services, the system comprising:
a set of stored instructions for execution by one or more computer processors for:
obtaining stored user profile data pertaining to the user of a network system of an institution;
comparing the user profile data to a plurality of different potential life stages in order to determine a selected life stage;
identifying one or more services from the platform of services based on the selected life stage;
identifying the one or more services to the user via a user interface of a user device;
receiving a request from the user through the user device for access to the one or more services; and
updating contents of the stored user profile to include additional profile content related to activity of the user with the one or more services.

19. A computer readable medium having a set of stored instructions for execution by one or more computer processors for manipulating and maintaining a user profile including applying user data for providing services to a user from a platform of services, the set of stored instructions including:
obtaining stored user profile data pertaining to the user of a network system of an institution;
comparing the user profile data to a plurality of different potential life stages in order to determine a selected life stage;
identifying one or more services from the platform of services based on the selected life stage;
identifying the one or more services to the user via a user interface of a user device;
receiving a request from the user through the user device for access to the one or more services; and
updating contents of the stored user profile to include additional profile content related to activity of the user with the one or more services.
